(19) United States
(12) Patent Application Publication
(10) Pub. No.: US 2019/0034147 A1
(43) Pub. Date: Jan. 31, 2019

(54) METHODS AND APPARATUS TO DETECT USER-FACING SCREENS OF MULTI-SCREEN DEVICES

(71) Applicant: Intel Corporation, Santa Clara, CA (US)

(72) Inventors: Tarakesava Reddy Koki, Bangalore (IN); Jagadish Vasudeva Singh, Bangalore (IN)

(21) Appl. No.: 15/665,072

(22) Filed: Jul. 31, 2017

(51) Int. Cl. G06F 3/14; G06F 1/16; G06F 3/041

(52) U.S. Cl. CPC G06F 3/1423; G06F 1/1647; G06F 2203/04104; G06F 1/1616; G06F 3/0412

(57) ABSTRACT

Methods and apparatus to detect user-facing screens of multi-screen devices are disclosed. An example computing device includes a touch point analyzer to detect a number of touch points on at least one of a first touchscreen and a second touchscreen of a multi-screen device in response to a trigger event. The example computing device includes a screen selector to designate one of the first and second touchscreens as an active screen and the other of the first and second touchscreens as an unused screen based on the number of touch points.

### FIELD OF THE DISCLOSURE

This disclosure relates generally to portable electronic devices, and, more particularly, to methods and apparatus to detect user-facing screens of multi-screen devices.

### BACKGROUND

Smartphones, tablets, and other types of portable electronic devices are becoming ubiquitous. Such devices come in many different shapes and sizes. One factor driving the overall footprint of such devices is the size of the display screens on the devices. Smaller screens typically correspond to devices that are more portable and/or easier for users to hold and manipulate in their hands. Larger screens correspond to devices that provide a greater area on which visual content or media may be rendered, which can facilitate the ease with which users may view and/or interact with (e.g., via a touch screen) the visual content.

### BRIEF DESCRIPTION OF THE DRAWINGS

FIG. 1 illustrates an example multi-screen device constructed in accordance with the teachings disclosed herein and shown in a closed position.

FIG. 2 illustrates the example multi-screen device of FIG. 1 opened a first extent to a book configuration with both screens positioned to face a user.

FIG. 3 illustrates the example multi-screen device of FIG. 1 opened a second extent to a tent configuration.

FIG. 4 illustrates the example multi-screen device of FIG. 1 opened a third extent to a tablet configuration with both screens facing outward away from the device.

FIG. 5 illustrates the example multi-screen device of FIGS. 1-4 being held by a user in a book configuration when viewed from the perspective of the user holding the device.

FIG. 6 illustrates the example multi-screen device of FIG. 5 held in the book configuration from a perspective of an onlooker facing the user.

FIG. 7 illustrates the example multi-screen device of FIGS. 1-6 folded into a tablet configuration and viewed from the perspective of the user holding the device.

FIG. 8 illustrates the example multi-screen device of FIG. 7 held in the tablet configuration from the perspective of an onlooker facing the user.

FIG. 9 illustrates the example multi-screen device of FIGS. 1-8 held in the tablet configuration after being rotated from the portrait orientation of FIG. 6 to a landscape orientation and shown from the perspective of the user.

FIG. 10 illustrates the example multi-screen device of FIG. 9 held in the tablet configuration in the landscape orientation from the perspective of an onlooker facing the user.

FIG. 11 illustrates the example multi-screen device of FIGS. 1-10 held in the position shown in FIG. 9 except with a different hand position of the user.

FIG. 12 illustrates an example implementation of the example screen controller of the multi-screen device of FIGS. 1-11.

FIG. 13 is a flowchart representative of example machine-readable instructions that may be executed to implement the example screen controller of FIG. 12 and, more generally, the example multi-screen device of FIGS. 1-11.

FIG. 14 is a block diagram of an example processor platform structured to execute the example machine-readable instructions of FIG. 13 to implement the example screen controller of FIG. 12 and, more generally, the example multi-screen device of FIGS. 1-11.

The figures are not to scale. Wherever possible, the same reference numbers will be used throughout the drawing(s) and accompanying written description to refer to the same or like parts.

### DETAILED DESCRIPTION

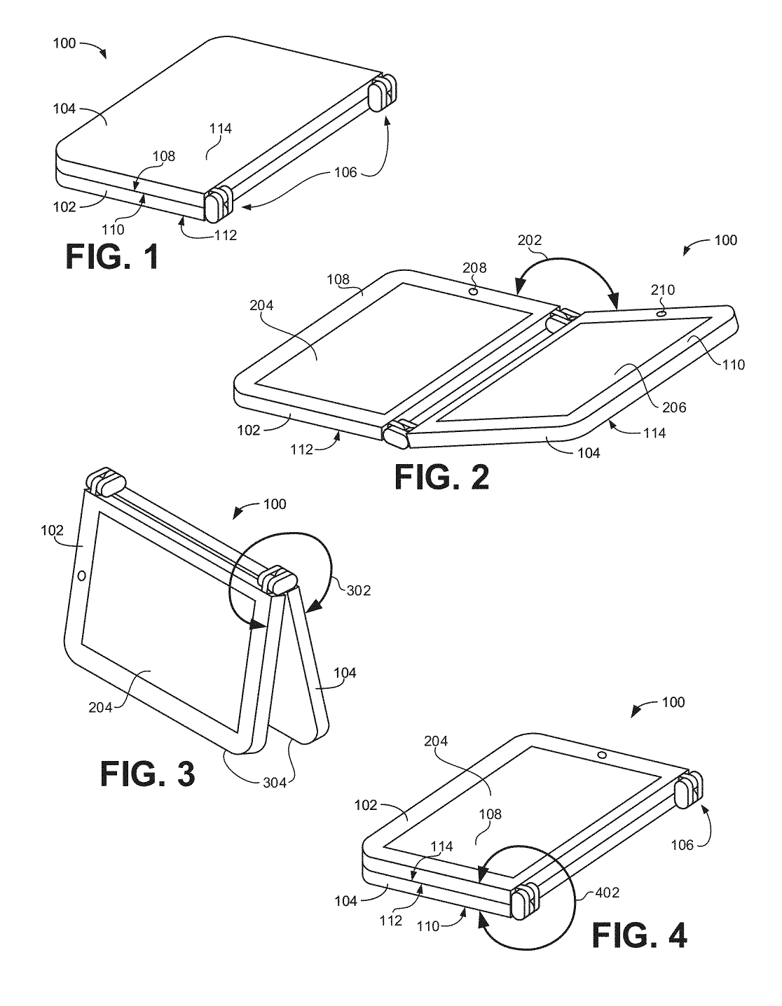

Manufacturers of portable electronic devices have begun developing devices with multiple display screens and devices with single screen that may be used in combination to increase the total area available for rendering visual media relative to a single one of the screens. In some such devices, separate screens may be independently positioned relative to one another for different configurations and/or uses of such multi-screen devices. For instance, FIGS. 1-4 illustrate an example multi-screen device 100 that includes two portions or housings 102, 104 coupled via hinges 106 or any other type of joint. In some examples, the first and second housings 102, 104 may correspond to standalone devices that may be detached and used independently or connected as shown to form a single composite device 100. In other examples, the first and second housings may be manufactured together with a permanent hinge 106. While the example device 100 includes two independently moveable housings 102, 104, other multi-screen devices implemented in accordance with this disclosure may have three or more devices that may be either permanently joined or selectively attached and detached to one another.

In the example of FIG. 1, the first housing 102 includes a front face or side 108 that has a first touchscreen 204 (shown in FIG. 2) and the second housing 104 includes a second front face or side 110 that has a second touchscreen 206 (shown in FIG. 2). In FIG. 1, the two housings 102, 104 are positioned in an example closed configuration in which the front sides 108, 110 are substantially parallel and facing one another, thereby concealing the touchscreens 204, 206 disposed within the closed housings 102, 104. In this closed configuration, back faces or sides 112, 114 of the respective first and second housings 102, 104 are facing outwards and in opposite directions away from each other. In this example, the back sides 112, 114 do not include display screens and, thus, provide surfaces for protecting the display screens of the device 100 during transport or the like. For instance, the housings 102, 104 may be placed in the closed configuration of FIG. 1 when the device is not being used.

In FIG. 2, the housings 102, 104 are opened a first extent 202 to an example book configuration in which a first touchscreen 204 on the front side 108 of the first housing 102 and a second touchscreen 206 on the front side 110 of the second housing 104 are both visible to a user. In the book configuration of FIG. 2, both of the touchscreens 204, 206 are visible from a single point of reference (e.g., by a single user) so that the touchscreens 204, 206 may be used in combination for a relatively large display area. In the illustrated example, the first housing 102 includes a first image sensor 208 and the second housing 104 includes a second image sensor 210. The image sensors 208, 210 may be cameras.

In FIG. 3, the housings 102, 104 are opened a second extent 302 to a tent configuration in which edges 304 of the housings 102, 104 may be placed on a supportive surface to enable two users on opposite sides of the device 100 to view opposite ones of the first or second touchscreens 204, 206. In FIG. 4, the housings 102, 104 are opened a third (e.g., full) extent 402 to a tablet configuration corresponding to when the back sides 112, 114 of the housings 102, 104 are facing each other such that the touchscreens 204, 206 (on the front sides 108, 110) are facing outward and in opposite directions away from each other. In this fully rotated position, the back sides 112, 114 may be touching and/or position in close (possibly parallel) proximity to one another.

In the tablet configuration of FIG. 4, a user may desire to use only one of the touchscreens 204, 206. While this provides a smaller display area than in the book configuration (FIG. 2), a user may choose to operate the device 100 in the tablet configuration (FIG. 4) because it is easier to hold and/or interact with than when in the book configuration. In some examples, when a user converts the device 100 from a book configuration (in which both touchscreens 204, 206 are displaying media) to the tablet configuration (in which the user may only be using one of the touchscreens 204, 206), the unused screen may be turned off or deactivated and the media on the active screen may be updated to include some or all of the media previously rendered on the unused screen.

Examples disclosed herein determine whether to designate either the first touchscreen 204 or the second touchscreen 206 as the active screen for the tablet configuration based on how the user holds the device 100 when being placed in the tablet configuration. If the screen facing away from the user becomes the active screen upon the device 100 being folded into the tablet configuration, the user will need to turn the device around before the user can begin using the device in the tablet configuration. This can reduce the user's experience with the device. Accordingly, it is desirable that the screen facing towards the user is designated as the active screen while the screen facing away from the user is designated as the unused screen and deactivated.

One solution to this problem is to always designate the same screen as the active screen in the tablet configuration so that users will know what to expect when they adjust the device 100 into the tablet configuration. While this would reduce user frustration overtime, it limits the freedom of users to use the device as they may desire and will not assist new users that are unaware which screen corresponds to the active screen. Furthermore, in examples where the first and second housings 102, 104 correspond to detachable standalone devices that may be interchanged with other similar housings, there is no simple way to define which housing 102, 104 is to be the default active screen.

Another solution is to detect the presence of the user using sensors (e.g., the image sensors 208, 210) on the device 100 to determine which of the touchscreens 204, 206 is facing the user. While this may work in some situations, human presence detection is relatively complex and can result in error, particularly when multiple people are near the device, because the device 100 may detect someone who is not using the device and activate the incorrect screen.

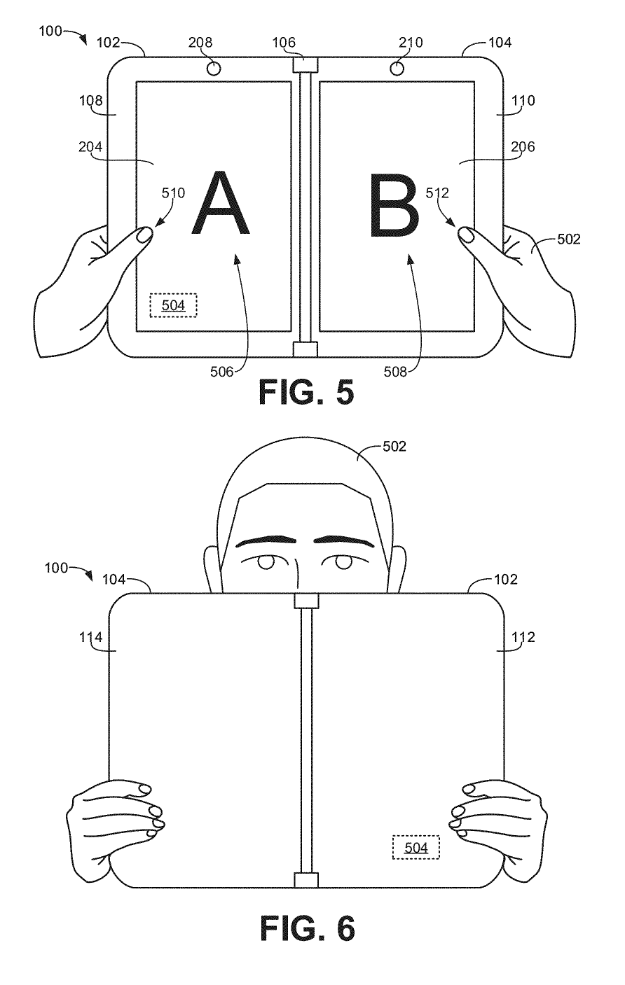

Examples disclosed herein improve upon the above solutions by determining which touchscreen 204, 206 should be designated as the active screen based on a count of the number of touch points on the first and second touchscreens 204, 206 at the time the multi-screen device 100 is folded into the tablet configuration. When a user is holding a tablet device in his or her hands, the user will typically place his or her fingers on the back or rear-facing side of the device (e.g., the side facing away from the user) and his or her thumbs on the front side of the device (e.g., the side facing the user). Using this as an underlying assumption, it is possible to detect which side of a multi-screen device in a tablet configuration (e.g., the device 100 in FIG. 4) is facing a user based on the number of touch points detected on each screen. If users are using both hands to hold the device, the screen on the front side of the device may detect up to two touch points corresponding to the two thumbs of the user. Therefore, more than two touch points detected on one of the screens indicates the corresponding screen is on the side of the device facing away from the user (i.e., when the fingers grasp the back side of the device 100). Thus, which touchscreen 204, 206 of the multi-screen device 100 that is facing a user may be detected without relying on complex and potentially error-prone human presence detection algorithms based on image data while still providing users with the freedom to fold or adjust the device 100 such that either touchscreen 204, 206 may face the users and become the active screen. Further detail is described with respect to the illustrated examples of FIGS. 5-11.

FIG. 5 illustrates the example multi-screen device 100 of FIGS. 1-4 being held by a user 502 in a book configuration from the perspective of the user 502 (e.g., showing the user-facing side of the device 100 (i.e., the side the user is looking at)). FIG. 6 illustrates the example device 100 held in the book configuration from a perspective of an onlooker facing the user 502 (e.g., showing the rear-facing or world-facing side of the device 100 opposite the side the user is looking at). From the perspective of the user 502, as represented in FIG. 5, the front sides 108, 110 of both the first and second housings 102, 104 are facing the user 502 and are, thus, viewable by the user. As such, the first and second touchscreens 204, 206 and the corresponding image sensors 208, 210 are also facing the user 502. By contrast, as shown in FIG. 6, the back sides 112, 114 of both housings 102, 104 are facing away from the user 502 and, thus, not currently visible to the user.

In the illustrated example, the first housing 102 includes a screen controller 504 to detect touches by the user and to control the display of media on the first and second touchscreens 204, 206. In some examples, the screen controller 504 may be housed in the second housing 104 and not in the first housing 102. In some examples, each of the first housing 102 and the second housing 104 carry separate screen controllers 504 corresponding to the first and second touchscreens 204, 206, respectively. In some such examples, the separate screen controllers 504 may be communicatively coupled. For purposes of explanation, the examples are described with respect to a single screen controller 504 in the first housing 102.

As shown in the illustrated example, the screen controller 504 renders a first portion 506 of media (represented by the letter “A”) via the first touchscreen 204 and a second portion 508 of media (represented by the letter “B”) via the second touchscreen 206. For example, if the device 100 were executing an email application, the first portion 506 of media may include a listing of emails in the user's inbox while the second portion 508 of media may include a display of a particular email message selected from the listing in the first portion 506. Different divisions of media are possible based on the particular application being executed and the type of media to be rendered. As used herein, media refers to media any type of content or advertisements including websites, webpages, advertisements, videos, still images, graphical user interfaces of applications executed on the device 100 and so forth. While this disclosure focuses on visual media, visual media may or may not be accompanied by audio.

As shown in FIGS. 5 and 6, the user 502 is holding the multi-screen device 100 using both hands with the fingers on the back sides 112, 114 of the housings 102, 104 and thumbs on the front sides 108, 110 of the housings 102, 104. More particularly, the thumbs of the user 502 are on the corresponding touchscreens 204, 206. Frequently, users may keep their thumbs off the touchscreens 204, 206 when not interacting with the screens to avoid causing touches or gestures that might unintentionally affect the application being rendered on the touchscreens. However, testing has shown that a grip similar to that shown in FIGS. 5 and 6 is common when users are adjusting the extent to which the housings 102, 104 are opened or rotated about the hinge 106. Thus, during such movement of the housing 102, 104, the screen controller 504 would detect one touch point 510 on the first touchscreen 204 and one touch point 512 on the second touchscreen 206.

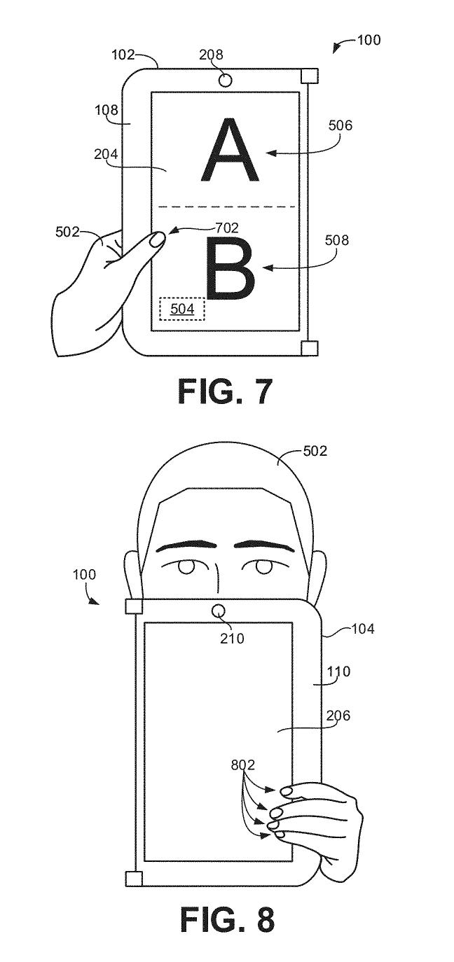

FIG. 7 illustrates the example device 100 of FIGS. 1-6 from the perspective of the user 502 (i.e., looking away from the face of the user 502 to the device 100) after being folded into a tablet configuration (e.g., showing the user-facing side of the device 100). FIG. 8 illustrates the example device 100 held in the tablet configuration from a perspective of an onlooker facing the user 502 (e.g., showing the rear-facing or world-facing side of the device 100 from the perspective of someone looking at or facing the user). As shown in the illustrated example, the user 502 is holding the device 100 in a similar manner to that shown in FIGS. 5 and 6 with the thumb on the side facing the user 502 (e.g., the front side 108 of the first housing 102 in FIG. 7) and the other fingers on the side facing away from the user 502 (e.g., the front side 110 of the second housing 104 in FIG. 8). Testing has shown that this is a common grip that users will use when closing the first and second housings 102, 104 into a tablet configuration. Whether the user 502 repositions his or her hands after initially converting the device 100 into the tablet configuration is irrelevant because the determination or designation of the active screen and unused screen is made immediately (e.g., within a threshold period of time (e.g., less than 1 second)) following the device 100 being placed into the tablet configuration. In any event, as shown in the illustrated example of FIG. 8, all four fingers are touching the second touchscreen 206. Accordingly, the screen controller 504 detects four touch points 802 on the second touchscreen 206. By contrast, as shown in FIG. 7, only the thumb is touching the first touchscreen corresponding to a single touch point 702 on the first touchscreen 204. In such examples, the screen controller 504 designates the second touchscreen 206 as the unused screen in the tablet configuration because the four touch points 802 are indicative of the user's fingers, which are assumed to be on the side facing away from the user. Therefore, the second touchscreen 206 is deactivated or turned off. At the same time, the screen controller 504 designates the first touchscreen 204 as the active screen in the tablet configuration. In some examples, the screen controller 504 adjusts or updates the media rendered on the active screen (e.g., the first touchscreen in FIG. 7) to include both the first and second portions 506, 508 of the media.

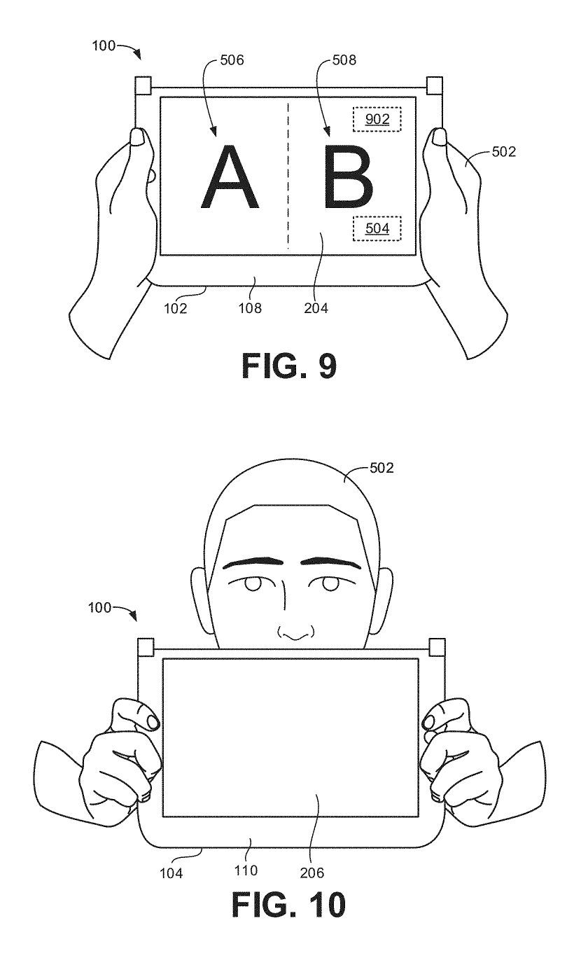

FIG. 9 illustrates the example device 100 of FIGS. 1-8 from the perspective of the user 502 in the tablet configuration after rotated to a landscape orientation. FIG. 10 illustrates the example device 100 held in the tablet configuration in the landscape orientation from a perspective of an onlooker facing the user 502 (as in FIG. 8). As shown in the illustrated example, in response to detecting the rotation of the device 100 to the landscape orientation (e.g., based on input from a position sensor 902 in the device 100 (e.g., a gyroscope, an accelerometer, etc.)), the screen controller 504 updates the media rendered on the active screen (i.e., the first screen 204). For example, the screen controller 504 may rotate the first and second portions 506, 508 of media according to the detected orientation of the device 100.

In some examples, once the device 100 is folded into the tablet configuration and the active screen is designated, this designation remains for as long as the device 100 remains in the tablet configuration and powered on. Thus, the number of touch points on either of the touchscreens 204, 206 after the user initially folds the device 100 into the tablet configuration is irrelevant. That is, regardless of how the user holds the device 100 after a threshold period of time following the device 100 being folded into the tablet configuration, the touchscreen 204, 206 designated as the active screen will remain so until the housings 102, 104 are moved out of the tablet configuration or the device 100 is powered off. Likewise, the touchscreen 204, 206 designated as the unused screen will remain designated as the unused screen until the device 100 is no longer in the tablet configuration or no longer powered on.

For example, as shown in FIGS. 9 and 10, the hands of the user 502 have been repositioned such that none of the user's fingers are touching the second touchscreen 206 and neither of the user's thumbs are touching the first touchscreen 204. That users may hold devices similar to the example device 100 during use to avoid accidental contact with the active screen, especially when there is a large bezel, does not does not preclude designation of the active screen between the first and second touchscreens 204, 206. This is so because the determination or designation of the active screen and the deactivation of the unused screen is determined in response to a trigger event corresponding to when the device is initially moved to the tablet configuration. Thereafter, the designation of the active screen will remain as initially determined until such time as the device 100 is moved out of the tablet configuration or the device 100 is powered off. Thus, users changing the position of their hands after initially transitioning to the tablet configuration is irrelevant to the disclosed examples.

Users typically initially touch the rear-facing screen (e.g., the screen facing away from the user) with their fingers at the time the device is initially converted into the tablet configuration. Furthermore, testing has shown that users commonly place their fingers on the rear-facing touchscreen (with their thumb on the user-facing screen) to provide a firm grip on the device during the transition from the book (or other) configuration to the tablet configuration. Therefore, detecting the number of touch points on the touchscreens 204, 206 in the first moments (e.g., within a threshold period) following a trigger event indicative of when the device 100 is initially placed in the tablet configuration is a reliable way to predict which screen is facing the user and, thus, is to be designated as the active screen thereby improving user experience. In some examples, the threshold period of time corresponds to 1 second or less (e.g., 10 milliseconds, 100 milliseconds, etc.) following the trigger event (i.e., detection of the device 100 being placed in the tablet configuration).

There may be circumstances where users fold the device 100 into the tablet configuration without a sufficient number of touch points to identify which of the touchscreen 204, 206 is facing the user. For example, a user that uses only two fingers on the rear-facing side and one thumb on the user-facing side to close the device 100 into the tablet configuration would result in only two touch points on the rear-facing side of the device 100. As described above, two touch points may also result from the user touching the user-facing screen with both thumbs (i.e., closing the device with both hands). Thus, in some examples, the unused screen (where the user's fingers are assumed to be located) is identified to correspond to the touchscreen 204, 206 because it is associated with more than two detected touch points. As mentioned above, testing has shown this is sufficient to identify the rear-facing screen in most situations such that the exceptions may be ignored as negligible.

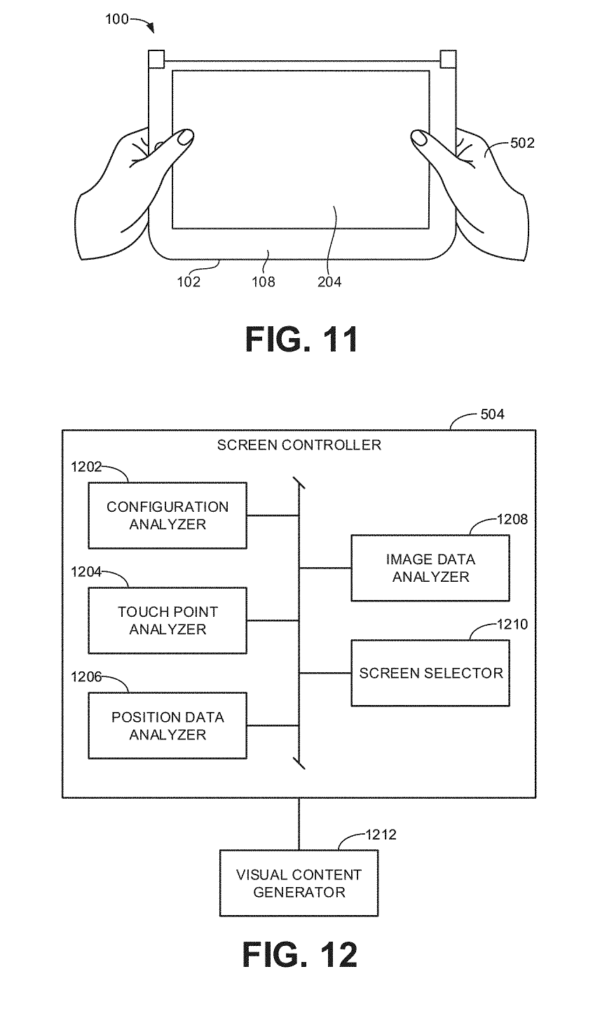

In other examples, a slightly more complex approach involves comparing the number of touch points on each of the touchscreen 204, 206 and designating the touchscreen associated with more touch points as the unused screen (assumed to be facing away from the user). Still further, in some examples, the relative position of the touch points on the touchscreens 204, 206 may be taken into consideration. For example, if two touch points are detected on a screen and located more than a threshold distance apart (e.g., more than 5 inches and/or in a certain physical pattern (e.g., on opposite sides near opposite edges) of the screen as shown in FIG. 11), the screen controller 504 may determine the two touch points correspond to different hands (e.g., each thumb) of the user. By contrast, if multiple touch points are located in relative close proximity to one another (e.g., within 2 inches of one another, in a cluster bounded by a circle with a diameter of 2 inches or less, etc.), the screen controller 504 may determine the touch points correspond to the fingers of a single hand of the user. Further, in some examples, the relative positions of the touch points on the opposite facing screens may be considered. For example, the screen controller 504 may detect that the location of a single touch point on one screen approximately corresponds to the location of a cluster of multiple touch points on the other screen to determine the single touch point corresponds to the user's thumb on a particular hand of the user and the cluster corresponds to the user's fingers on the same hand as the user's thumb and fingers are used to grasp the device 100.

While the above example considerations are expected to enable proper identification of a user-facing screen of the multi-screen device 100 in the tablet configuration, there may be situations where more touch points are detected on the screen a user desires to use (i.e., the user-facing screen) than on the opposite screen (i.e., the rear-facing screen). For example, users may place one of the touchscreens 204, 206 face down on their laps, a table, or other surface and then use their hand (including fingers and thumb) to press the upward facing touchscreen down into the tablet configuration. In such a situation, users are expecting the upward facing screen to become the active screen. However, at the time the device 100 is placed into the tablet configuration, no touch points may be detected on the downward facing screen (e.g., because the housing rim typically include a raised lip to reduce contact between a table or the like and the touchscreen) and it is likely that more than two touch points will be detected on the upward facing screen. Using the above approach, the screen controller 504 might designate the upward facing screen as the unused screen and the downward facing screen as the active screen giving rise to the need for the user to flip the device 100 over before using it. In some examples, this problem is avoided by training users to fold the device 100 into the tablet configuration before placing it on the support surface. However, in other examples, if the upward facing screen includes multiple touch points, with no touch points associated with the downward facing screen, the upward facing screen may be identified as active. Other tests may be implemented in these circumstances. For example, if some or all of the touch points are in a center area of the screen, that would indicate the device is likely not being placed into a tablet configuration with the user's fingers on one side and their thumb(s) on the other side because the center is not reachable by a hand gripping the edge of the device

Further, in some examples, a methodology is implemented that involves the use of data from sensors in the device 100 beyond the number and/or position of touch points on the touchscreens 204, 206. For instance, if no touch points are detected on at least one of the touchscreens 204, 206, the assumed situation where users are closing the device 100 into the tablet configuration with their fingers on one side and their thumbs on the other side has not occurred. Accordingly, the screen controller 504 may analyze position data from the position sensor 902 to determine an orientation of the device 100. If the position data indicates at least side 108, 110, 112, 114 of the device 100 is relatively horizontal (e.g., within a suitable threshold (e.g., 5 degrees, 10 degrees, 15 degrees)), the screen controller 504 may designate the upward facing screen as the active screen on the assumption that the device is resting on a support surface (e.g., a table). In some examples, the screen controller 504 may designate whichever touchscreen 204, 206 is facing more upwards regardless of the particular angle of inclination on the assumption that users typically hold the device 100 below eye level such that the screen they desire to view is inclined at least somewhat upwards. Some uses of the device 100 may involve users holding the device above their heads with the active screen facing downwards (e.g., if the users are lying down while facing up in a supine position). However, in many such instances, it is likely that the user will adjust the device 100 into the tablet configuration before lifting it above their heads such that at the time the tablet configuration is initially detected, the upward facing touchscreen is the intended active screen.

In some examples, in addition to orientation, the position data may indicate the amount of movement and/or stability of each of the housings 102, 104 and/or the relative movement or stability of the housings. Based on such information, the screen controller 504 may determine when one of the housings 102, 104 is moving relatively little (e.g., is substantially stable) while the other housings 102, 104 is moving (e.g., rotating relative to the first housing) relatively fast. In such examples, the touchscreen 204, 206 associated with the relatively stable housing 102, 104 may be designated as the unused screen on the assumption that it is not moving because it has been placed face down on a stable surface while the other housing 102, 104 (detected to be moving) is being closed thereon. Thus, the screen controller 504 may designate the touchscreen 204, 206 associated with the moving housing 102, 104 as the active screen. This approach may be implemented regardless of whether the device 100 is positioned on a horizontally support surface or an inclined support surface. Inasmuch as the relative movement of the housings 102, 104 occurs prior to the device 100 being placed in the tablet mode, in some examples, the screen controller 504 keeps track of the position data (e.g., movement and/or orientation) of each of the housings 102, 104 for a relatively brief period of rolling time (e.g., 1 second, 2 seconds, etc.). In this manner, the position data immediately preceding detection of the device 100 entering the tablet mode may be retrieved and analyzed as described above.

Additionally or alternatively, the screen controller 504 may analyze image data from the image sensors 208, 210 to predict which of the touchscreens 204, 206 is facing the user. For example, if one of the image sensors 208, 210 detects substantially no light, the screen controller 504 may designate the corresponding touchscreen 204, 206 as the unused screen because the screen is facing a table or other support surface that is blocking light from being detected by the image sensor 208, 210.

Another potential anomaly from the assumed situation of more than two touch points being detected on the unused screen and no more than two touch points on the active screen may occur when each of the touchscreens 204, 206 detects more than two touch points indicating the user's fingers are contacting both touchscreens 204, 206. Whether or not the number of touch points on each touchscreen is the same, the number of touch points on each side exceeding two indicates the user's fingers are touching both screens such that the screen controller 504 may not reliably determine the rear-facing screen based on which is in contact with user fingers. In some such examples, the screen controller 504 continues to monitor the touch points on both touchscreens 204, 206 until the number of touch points on one of the screens drops to two or fewer touch points. In such examples, the touchscreen 204, 206 to be associated with two or fewer touch points is designated as the active screen while the other screen (that remains with more than two touch points) is associated with the unused screen on the assumption that the user has retained fingers on the unused screen to hold or support the device 100 and removed fingers from the active screen so as not to unintentional cause a touch or gesture on the screen.

FIG. 12 illustrates an example implementation of the screen controller 504 of the multi-screen device 100 of FIGS. 1-11. In the illustrated example, the screen controller 504 includes an example configuration analyzer 1202, an example touch point analyzer 1204, an example position data analyzer 1206, an example image data analyzer 1208, and an example screen selector 1210.

The example screen controller 504 is provided with the example configuration analyzer 1202 to monitor and determine the configuration of the device 100. For example, the configuration analyzer 1202 may determine whether the device 100 is in a closed configuration (similar to FIG. 1), in a book configuration (similar to FIGS. 2, 5, and 6), in a tent configuration (similar to FIG. 3), or in a tablet configuration (similar to FIGS. 4 and 7-11). In some examples, the configuration analyzer 1202 determines the configuration of the device based on the angle or extent that the first and second housings are opened relative to the closed configuration. For example, the book configuration corresponds to angles of rotation (e.g., the first extent 202 of FIG. 2) ranging from a minimum opening threshold (e.g., 5 degrees) to an upper threshold (e.g., 270 degrees). Angles of rotation above this upper threshold (e.g., the second extent 302 in FIG. 4) may correspond to the tent configuration until the angle of rotation reaches 360 degrees of rotation (e.g., the third extent 402 of FIG. 4), which corresponds to the tablet configuration.

In some examples, the particular angle of rotation may not matter. Rather, the example configuration analyzer 1202 determines the configuration of the device 100 based on different input data. For example, the device 100 may include one or more proximity sensors or switches that detect when the first and second housings 102, 104 are closed adjacent one another with the touchscreens 204, 206 facing each other (e.g., the closed configuration) and when the first and second housings 102, 104 are closed adjacent one another with the touchscreens 204, 206 facing outward (e.g., the tablet configuration). When theses sensor(s) or switch(es) are activated, the example configuration analyzer 1202 of this example determines the device 100 is either in the closed configuration or the tablet configuration. When the first and second housings 102, 104 are opened to some extent between these two extremes, the example configuration analyzer 1202 determines whether the device 100 is in the book configuration or the tent configuration based on position data indicative of the orientation of the first and second housings 102, 104.

In the illustrated example of FIG. 12, the screen controller 504 is provided with the example touch point analyzer 1204 to determine the number and/or location of touch points on each of the first and second touchscreens 204, 206. The example screen controller 504 is provided with the example position data analyzer 1206 to obtain and analyze position data provided by one or more position sensors 902. As explained above, the position data may include orientation information indicative of the orientation of either of the housings 102, 104 that may be used to determine how to orient content on the touchscreens 204, 206 (e.g., in landscape mode or portrait mode). Further, the orientation information contained in the position data may be used to determine the direction each of the touchscreens 102, 104 are facing (e.g., upwards, downwards, etc.). Additionally or alternatively, in some examples, the position data includes motion information indicative of the movement or stability of the housings 102, 104. In some examples, the motion information may indicate the movement of each housing 102, 104 independently. In other examples, the motion information may indicate a relative movement of one of the housings 102, 104 with respect to the other housing. Such information may be analyzed by the position data analyzer 1206 to assist in designating the touchscreens 204, 206 as either active or unused when the device 100 is placed in the tablet configuration.

The example screen controller 504 of FIG. 12 is provided with the example image data analyzer 1208 to obtain and analyze image data provided by one or more image sensors 208, 210. The image data may be analyzed to assist in identifying which of the first or second touchscreens 204, 206 is facing the user 502 in situations where such cannot be identified based on the touch points (or lack thereof) on each of the touchscreens 204, 206.

In the illustrated example of FIG. 12, the screen controller 504 is provided with the example screen selector 1210 to select or designate which of the touchscreens 204, 206 are to be powered on and to display media based on the configuration and/or the orientation of the housings 102, 104 of the device 100. When the configuration analyzer 1202 determines the device 100 is in the closed configuration (as represented in FIG. 1), the example screen selector 1210 may determine to turn off both of the touchscreens 204, 206. When the configuration analyzer 1202 determines the device 100 is in either the book or tent configurations (as represented in FIGS. 2 and 3), the example screen selector 1210 may determine to turn on both of the touchscreens 204, 206. However, when the configuration analyzer 1202 determines the device 100 is in the tablet configuration (as represented in FIG. 4), the example screen selector 1210 may select one of the touchscreens 204, 206 to be the active screen that is powered on while the other touchscreen 204, 206 is designated as the unused screen to be deactivated or powered off. In some examples, which of the touchscreens 204, 206 is designated as the active screen and which is designated as the unused screen is based on one or more of the detected touch points, the position data, and the image data.

In the illustrated example of FIG. 12, the screen controller 504 is in communication with a visual content generator 1212 executed on the device 100. In this example, the visual content generator 1212 is shown as being external to the screen controller 504. In other examples, the screen controller 504 may include the visual content generator. The visual content generator 1212 serves to generate or control the display of visual content or media on the touchscreens 204, 206 that are currently active and powered. That is, if both touchscreens 204, 206 are on, the example visual content generator 1212 determines how media associated with a graphical user interface of an application being executed on the device 100 is to be displayed across both screens. If the device 100 is in the tablet configuration such that only one of the touchscreens 204, 206 is powered and in use as the active screen (as designated by the screen controller 504), the example visual content generator 1212 determines how to adjust the media to be rendered within the single screen.

While an example manner of implementing the screen controller 504 of FIG. 5 is illustrated in FIG. 12, one or more of the elements, processes and/or devices illustrated in FIG. 12 may be combined, divided, re-arranged, omitted, eliminated and/or implemented in any other way. Further, the example configuration analyzer 1202, the example touch point analyzer 1204, the example position data analyzer 1206, the example image data analyzer 1208, the example screen selector 1210, and/or, more generally, the example screen controller 504 of FIG. 12 may be implemented by hardware, software, firmware and/or any combination of hardware, software and/or firmware. Thus, for example, any of the example configuration analyzer 1202, the example touch point analyzer 1204, the example position data analyzer 1206, the example image data analyzer 1208, the example screen selector 1210, and/or, more generally, the example screen controller 504 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example configuration analyzer 1202, the example touch point analyzer 1204, the example position data analyzer 1206, the example image data analyzer 1208, and/or the example screen selector 1210 is/are hereby expressly defined to include a non-transitory computer readable storage device or storage disk such as a memory, a digital versatile disk (DVD), a compact disk (CD), a Blu-ray disk, etc. including the software and/or firmware. Further still, the example screen controller 504 of FIG. 12 may include one or more elements, processes and/or devices in addition to, or instead of, those illustrated in FIG. 12, and/or may include more than one of any or all of the illustrated elements, processes and devices.

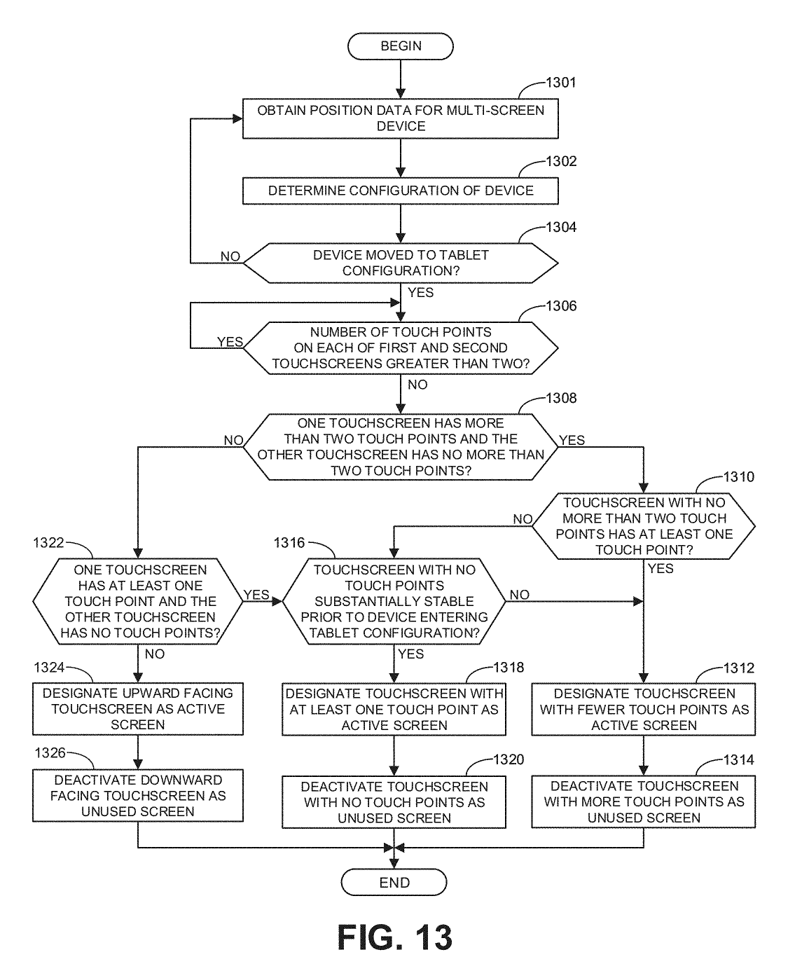

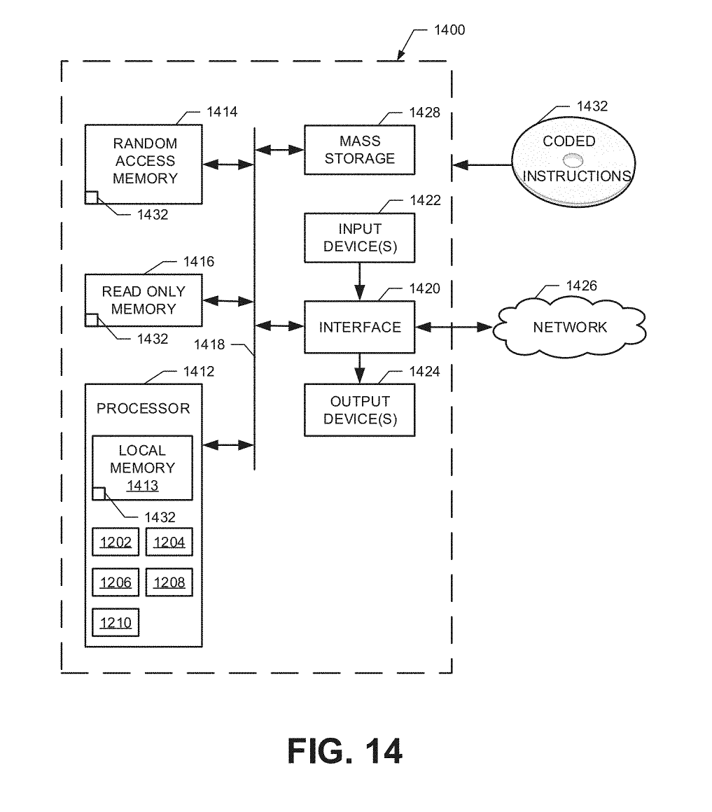

A flowchart representative of example machine readable instructions for implementing the screen controller 504 of FIG. 12 is shown in FIG. 13. In this example, the machine readable instructions comprise a program for execution by a processor such as the processor 1412 shown in the example processor platform 1400 discussed below in connection with FIG. 14. The program may be embodied in software stored on a non-transitory computer readable storage medium such as a CD-ROM, a floppy disk, a hard drive, a digital versatile disk (DVD), a Blu-ray disk, or a memory associated with the processor 1412, but the entire program and/or parts thereof could alternatively be executed by a device other than the processor 1412 and/or embodied in firmware or dedicated hardware. Further, although the example program is described with reference to the flowchart illustrated in FIG. 13, many other methods of implementing the example screen controller 504 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, a Field Programmable Gate Array (FPGA), an Application Specific Integrated circuit (ASIC), a comparator, an operational-amplifier (op-amp), a logic circuit, etc.) structured to perform the corresponding operation without executing software or firmware.

As mentioned above, the example process of FIG. 13 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. “Including” and “comprising” (and all forms and tenses thereof) are used herein to be open ended terms. Thus, whenever a claim lists anything following any form of “include” or “comprise” (e.g., comprises, includes, comprising, including, etc.), it is to be understood that additional elements, terms, etc. may be present without falling outside the scope of the corresponding claim. As used herein, when the phrase “at least” is used as the transition term in a preamble of a claim, it is open-ended in the same manner as the term “comprising” and “including” are open ended.

FIG. 13 is a flowchart representative of machine executable instructions that may be executed to implement the example screen controller 504 of FIG. 12. The program of FIG. 13 begins at block 1301 where the example position data analyzer 1206 obtains position data for a multi-screen device (e.g., the multi-screen device 100). In some examples, the position data is collected and stored on a rolling basis over a relatively brief period of time (e.g., 1 second, 2 seconds, etc.) from position sensors (e.g., gyroscopes, accelerometers, etc.) in device 100. At block 1302, the example screen controller 504 determines the configuration of the device 100. The device 100 may be in the book configuration (e.g., as shown in FIG. 5) but may alternatively be in any other configuration at the beginning of this example. However, for purposes of explanation, in the illustrated example, it is assumed that the device does not begin in the tablet configuration (e.g., as shown in FIG. 7). As a result, at block 1304, the example configuration analyzer 1202 determines whether the device 100 has moved to a tablet configuration. If not, control returns to block 1301. If the example configuration analyzer 1202 determines that the device 100 has moved to a tablet configuration (block 1304), control advances to block 1306, where the example touch point analyzer 1204 determines whether the number of touch points on each of first and second touchscreens (e.g., the touchscreens 204, 206) is greater than two. If so, control remains at block 1306 until at least one of the touchscreens 204, 206 has no more than two touch points. This accounts for the situation where a user may touch both touchscreens 204, 206 with their fingers while converting the device 100 to the tablet configuration.

If, at block 1306, the example touch point analyzer 1204 determines that the number of touch points on each of the first and second touchscreens 204, 206 is not greater than two (i.e., at least one has two or fewer touch points), control advances to block 1308. At block 1308, the example touch point analyzer 1204 determines whether one of the touchscreens 204, 206 has more than two touch points and the other touchscreen 204, 206 has no more than two touch points. If so, control advances to block 1310 where the example touch point analyzer 1204 determines whether the touchscreen 204, 206 with no more than two touch points has at least one touch point. If so, the at least one touch point (but not more than two touch points) is likely to correspond to the user's thumb(s) with the more than two touch points on the other touchscreen 204, 206 corresponding to the user's fingers. As mentioned above, testing has shown that this is the most typical situation when users are initially converting the multi-screen device 100 into the tablet configuration. While user's may move the position of their hands thereafter, this has no bearing on the example process because the process occurs within a threshold period of time following detection of the device 100 being moved into the tablet configuration (at block 1304).

Thus, if the example touch point analyzer 1204 determines that the touchscreen 204, 206 with no more than two touch points has at least one touch point (block 1310), control advances to block 1312 where the example screen selector designates the touchscreen 204, 206 with fewer touch points as the active screen. At block 1314, the example screen selector deactivates the touchscreen 204, 206 with more touch points as the unused screen. Thereafter, the example process of FIG. 13 ends with one touchscreen 204, 206 designated as active and the other is designated as unused and deactivated. Following this process, the example visual content generator 1212 may update the display of media on the active screen. For example, the visual content generator 1212 may adjust the display of media on the active screen to include the portion of media previously being rendered via the other screen now deactivated.

Returning to block 1310, if the example touch point analyzer 1204 determines that the touchscreen 204, 206 with no more than two touch points does not have at least one touch point (i.e., it has zero touch points), control advances to block 1316. This situation, where one touchscreen has more than two touch points (as determined at block 1308) and a second touchscreen has no touch points (as determined at block 1310) may result from the situations where users place one of the touchscreens 204, 206 face down on a surface (e.g., their laps, a table, etc.) and use their fingers on the other touchscreen to place the device 100 in the tablet configuration. To confirm this, at block 1316, the example position data analyzer 1206 determines whether the touchscreen 204, 206 with fewer touch points (zero touch points in this instance based on the determination at block 1310) was substantially stable (e.g., within a certain threshold relative to no movement and/or relative to the other touchscreen) prior to the device 100 entering tablet configuration. The position data analyzer 1206 may make this determination based on the position data obtained at block 1301 just prior to the device 100 being moved to the tablet configuration (detected at block 1304). If the touchscreen 204, 206 with no touch points is not substantially stable, it may be assumed that the device 100 was not placed on a support surface and that the users were converting the device to the tablet configuration in their hands without placing their thumbs on the screen facing towards them. Accordingly, in such circumstances, control advances to block 1312 to designate the active screen based on which touchscreen 204, 206 has fewer touch points (in this instance, zero touch points) as described above.

If the example position data analyzer 1206 determines that the touchscreen with fewer touch points was substantially stable (block 1316), control advances to block 1318 where the example screen selector 1210 designates the touchscreen 204, 206 with at least one touch point as the active screen. At block 1320, the example screen selector 1210 deactivates the touchscreen 204, 206 with no touch points as the unused screen. Thereafter, the example process of FIG. 13 ends. Additionally or alternatively, in some examples, identification of the active and unused screens at blocks 1318 and 1320 may be based on image data analyzed by the image data analyzer 1208. For example, the image data analyzer 1208 may compare the amount of light detected by the image sensor 208, 210 associated with each touchscreen 204, 206. If the device 100 has been placed on a support surface with one of the touchscreens 204, 206 facing the surface, the associated image sensor 208, 210 is unlikely to detect much, if any, light. Accordingly, the touchscreen 204, 206 associated with the image sensor 208, 210 that detects more light is designated as the active screen while the other touchscreen 204 is deactivated as the unused screen.

Returning to block 1308, the example touch point analyzer 1204 may determine that neither of the touchscreens 204, 206 has more than two touch points. If so, there is no way to directly determine which touchscreen 204, 206 is being touched by the user's fingers (if any) and which touchscreen 204, 206 is being touched by the user's thumbs (if any). However, identifying the active and unused screens may still be possible based on additional information (e.g., position data and/or image data). At block 1322, the example touch point analyzer 1204 determines whether one touchscreens 204, 206 has at least one touch point and the other touchscreen has no touch points. If so, control advances to block 1316 to determine whether the touchscreen 204, 206 with no touch points was substantially stable as described above. If the example touch point analyzer 1204 does not determine that one touchscreen 204, 206 has at least one touch point and the other touchscreen has no touch points (e.g., the touchscreens 204, 206 each have at least one touch point but not more than two (per block 1308) or both have no touch points), control advances to block 1324.

At block 1324, the example screen selector 1210 designates the upward facing touchscreen 204, 206 as the active screen. At block 1326, the example screen selector 1210 deactivates the downward facing touchscreen 204, 206 as the unused screen. In some examples, the upward and downward facing touchscreens 204, 206 may be identified based on position data analyzed by the position data analyzer 1206. In some examples, inasmuch as the touchscreens 204, 206 are substantially parallel and facing away from each other (when in the tablet configuration), any inclination of the device 100 will result in one touchscreen facing generally upwards while the other touchscreen is facing generally downwards a similar extent. Accordingly, in some examples, the particular angle of orientation of the upward and downward facing touchscreens 204, 206 is irrelevant. If the device 100 is exactly vertical at the time the device 100 is moved into the tablet configuration, the screen selector 1210 designate the upward and downward facing touchscreens 204, 206 based on the orientation to which the device 100 is moved after the initial detection of the tablet configuration. Thereafter, the example process of FIG. 13 ends.

As mentioned above, although the example process of FIG. 13 assumes the device 100 does not begin in the tablet configuration, in some examples, the device 100 may be turned on when already positioned in the tablet configuration. In such situations, during the boot operations, the screen controller 504 may detect the position of any touch points on either of the touchscreens 204, 206 to predict which of the screens is facing the user in a similar manner as described above. Further, in some examples, the screen controller 504 may use additional information such as, for example, position data and/or image data obtained during the boot process to designate one of the touchscreens 204, 206 as the active screen and the other as the unused screen.

FIG. 14 is a block diagram of an example processor platform 1400 capable of executing the instructions of FIG. 13 to implement the screen controller 504 of FIG. 12. The processor platform 1400 can be, for example, a personal computer, a mobile device (e.g., a cell phone, a smart phone, a tablet such as an iPad™), a personal digital assistant (PDA), or any other type of computing device.

The processor platform 1400 of the illustrated example includes a processor 1412. The processor 1412 of the illustrated example is hardware. For example, the processor 1412 can be implemented by one or more integrated circuits, logic circuits, microprocessors or controllers from any desired family or manufacturer. The hardware processor may be a semiconductor based (e.g., silicon based) device. In this example, the processor implements the example configuration analyzer 1202, the example touch point analyzer 1204, the example position data analyzer 1206, the example image data analyzer 1208, and the example screen selector 1210. The processor may implement other instructions to implement other functions (e.g., native functions of the device) such as the visual content generator 1212.

The processor 1412 of the illustrated example includes a local memory 1413 (e.g., a cache). The processor 1412 of the illustrated example is in communication with a main memory including a volatile memory 1414 and a non-volatile memory 1416 via a bus 1418. The volatile memory 1414 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1416 may be implemented by flash memory and/or any other desired type of memory device. Access to the main memory 1414, 1416 is controlled by a memory controller.

The processor platform 1400 of the illustrated example also includes an interface circuit 1420. The interface circuit 1420 may be implemented by any type of interface standard, such as an Ethernet interface, a universal serial bus (USB), and/or a PCI express interface.

In the illustrated example, one or more input devices 1422 are connected to the interface circuit 1420. The input device(s) 1422 permit(s) a user to enter data and/or commands into the processor 1412. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1424 are also connected to the interface circuit 1420 of the illustrated example. The output devices 1424 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 1420 of the illustrated example, thus, typically includes a graphics driver card, a graphics driver chip and/or a graphics driver processor.

The interface circuit 1420 of the illustrated example also includes a communication device such as a transmitter, a receiver, a transceiver, a modem and/or network interface card to facilitate exchange of data with external machines (e.g., computing devices of any kind) via a wired or wireless network 1426 (e.g., an Ethernet connection, a digital subscriber line (DSL), a telephone line, coaxial cable, a cellular telephone system, etc.).

The processor platform 1400 of the illustrated example also includes one or more mass storage devices 1428 for storing software and/or data. Examples of such mass storage devices 1428 include floppy disk drives, hard drive disks, compact disk drives, Blu-ray disk drives, RAID systems, and digital versatile disk (DVD) drives.

The coded instructions 1432 of FIG. 13 may be stored in the mass storage device 1428, in the volatile memory 1414, in the non-volatile memory 1416, and/or on a removable tangible computer readable storage medium such as a CD or DVD.

From the foregoing, it will be appreciated that example methods, apparatus and articles of manufacture have been disclosed that enable designation of an active screen on a multi-screen device that has been placed in a tablet configuration. Disclosed examples designate the active screen by analyzing the number of touch points detected on each outward facing screen. More particularly, this is made possible based on the finding that when users initially arrange such multi-screen devices into a tablet configuration they typically place their fingers on the rear-facing screen and their thumb(s) on the user-facing screen. As such, the particular touchscreen that is facing the user can reliably be identified without the complexity or processing requirements of detecting user in proximity to the device based on image data and/or other sensed data. Furthermore, allowing any touchscreen of a multi-screen device to be designated as the active screen (rather than designating one screen by default) enhances user experience with the device because users are not limited in the way they are to arrange the screens to have the user-facing screen function as the active screen.

Example 1 is computing device that includes a first housing having a first front side opposite a first back side. A first touchscreen is on the first front side of the first housing. The computing device further includes a second housing having a second front side opposite a second back side. A second touchscreen is on the second front side of the second housing. The first and second housings positionable in a tablet configuration with the first back side facing the second back side on the second housing. The computing device further includes at least one processor to designate one of the first and second touchscreens as an active screen and the other of the first and second touchscreens as an unused screen based on touch points detected on at least one of the first and second touchscreens when the first and second housings are in the tablet configuration.

Example 2 includes the subject matter of Example 1, wherein the at least one processor is to at least one of render media of a graphical user interface via the active screen and deactivate the unused screen.

Example 3 includes the subject matter of claim 1 or 2, wherein the touch points are detected within a threshold period of time following the first and second housings initially being positioned in the tablet configuration.

Example 4 includes the subject matter of claims 1-3, wherein the first and second housings are detachable from one another.

Example 5 includes the subject matter of claims 1-4, wherein the first and second housings are attached via a hinge. The first and second housings are adjustable about the hinge to move between the tablet configuration and a book configuration. Both the first touchscreen and the second touchscreen are visible from a single point of reference in the book configuration.

Example 6 includes the subject matter of claim 5, wherein the at least one processor is to render a first portion of media via the first touchscreen and a second portion of the media via the second touchscreen when the first and second housings are in the book configuration. The at least one processor is to render both the first and second portions of the media via the active screen when the first and second housings are in the tablet configuration.

Example 7 includes the subject matter of claims 1-6, wherein the at least one processor designates the first touchscreen as the active screen when more than two of the touch points are detected on the second touchscreen at a single point in time.

Example 8 includes the subject matter of claims 1-6, wherein the at least one processor designates the first touchscreen as the active screen when more of the touch points are detected on the second touchscreen than on the first touchscreen at a point in time.

Example 9 includes the subject matter of claim 8, wherein a number of the touch points detected on the first touchscreen is at least one at the point in time.

Example 10 includes the subject matter of anyone of Examples 1-9, wherein the at least one processor designates the first touchscreen as the active screen when (1) at least one touch point is detected on the first touchscreen and no touch points are detected on the second touchscreen, and (2) the second housing is substantially stable during a threshold period of time preceding when the first and second housings are positioned in the tablet configuration.

Example 11 is a computing device that includes a touch point analyzer to detect a number of touch points on at least one of a first touchscreen and a second touchscreen of a multi-screen device in response to a trigger event. The computing device includes a screen selector to designate one of the first and second touchscreens as an active screen and the other of the first and second touchscreens as an unused screen based on the number of touch points.

Example 12 includes the subject matter of Example 11, wherein media is to be rendered via the active screen and the unused screen is to be deactivated.

Example 13 includes the subject matter of anyone of Examples 11 or 12, wherein the number of touch points are detected within a threshold period of time following the trigger event.

Example 14 includes the subject matter of anyone of Examples 11-13, wherein the first touchscreen is associated with a first housing of the multi-screen device and the second touchscreen is associated with a second housing of the multi-screen device.

Example 15 includes the subject matter of Example 14, wherein the first and second housings are detachable from one another.

Example 16 includes the subject matter of Example 14, wherein the first and second housings are permanently attached via a hinge. The first housing is rotatable about the hinge relative to the second housing to adjust the multi-screen device between the tablet configuration and a book configuration. Both the first touchscreen and the second touchscreen are visible from a single point of reference in the book configuration.

Example 17 includes the subject matter of Example 16, wherein the first touchscreen is to display a first portion of media and the second touchscreen is to display a second portion of the media when the multi-screen device is in the book configuration. The active screen is to display both the first and second portions of the media when the multi-screen device is in the tablet configuration.

Example 18 includes the subject matter of anyone of Examples 11-17, wherein the screen selector designates the first touchscreen as the active screen when the number of touch points detected on the second touchscreen is more than two at a point in time.

Example 19 includes the subject matter of anyone of Examples 11-17, wherein the screen selector designates the first touchscreen as the active screen when the number of touch points detected on the second touchscreen is greater than the number of touch points detected on the first touchscreen at a point in time.

Example 20 includes the subject matter of Example 19, wherein the number of touch points detected on the first touchscreen is at least one at the point in time.

Example 21 includes the subject matter of anyone of Examples 11-20, wherein the trigger event corresponds to when the multi-screen device is placed into a tablet configuration, the tablet configuration defined by the first and second touchscreens facing outwards and in opposite directions away from the multi-screen device

Example 22 includes the subject matter of Example 21, wherein the screen selector designates the first touchscreen as the active screen when (1) at least one touch point is detected on the first touchscreen and no touch points are detected on the second touchscreen, and (2) the second touchscreen is substantially stable during a threshold period of time preceding when the multi-screen device is positioned in the tablet configuration.

Example 23 is a non-transitory computer readable medium comprising instructions that, when executed, cause a machine to at least analyze touch points on at least one of a first touchscreen and a second touchscreen of a multi-screen device in response to a trigger event. The instructions, when executed, also cause the machine to designate one of the first or second touchscreens as an active screen and the other of the first or second touchscreens as an unused screen based on the touch points.

Example 24 includes the subject matter of Example 23, wherein media is to be rendered via the active screen and the unused screen is to be deactivated.

Example 25 includes the subject matter of anyone of Examples 23 or 24, wherein the touch points are detected within a threshold period of time following the trigger event.

Example 26 includes the subject matter of anyone of Examples 23-25, wherein the first touchscreen is associated with a first housing of the multi-screen device and the second touchscreen is associated with a second housing of the multi-screen device.

Example 27 includes the subject matter of Example 26, wherein the first and second housings are detachable from one another.

Example 28 includes the subject matter of Example 26, wherein the first and second housings are attached via a hinge. The first housing is rotatable about the hinge relative to the second housing to adjust the multi-screen device between the tablet configuration and a book configuration. Both the first touchscreen and the second touchscreen are visible from a single point of reference in the book configuration.

Example 29 includes the subject matter of Example 28, wherein the instructions further cause the machine to render a first portion of media via the first touchscreen and a second portion of the media via the second touchscreen when the multi-screen device is in the book configuration, and render both the first and second portions of the media via the active screen when the multi-screen device is in the tablet configuration.

Example 30 includes the subject matter of anyone of Examples 23-29, wherein the instructions further cause the machine to designate the first touchscreen as the active screen when the number of touch points detected on the second touchscreen is more than two at a single point in time.

Example 31 includes the subject matter of anyone of Examples 23-29, wherein the instructions further cause the machine to designate the first touchscreen as the active screen when the number of touch points detected on the second touchscreen is greater than the number of touch points detected on the first touchscreen at a point in time.

Example 32 includes the subject matter of Example 31, wherein the number of touch points detected on the first touchscreen is at least one at the point in time.

Example 33 includes the subject matter of anyone of Examples 23-32, wherein the trigger event corresponds to when the multi-screen device is placed into a tablet configuration. The tablet configuration defined by the first and second touchscreens facing outwards and in opposite directions away from the multi-screen device.

Example 34 includes the subject matter of Example 33, wherein the instructions further cause the machine to designate the first touchscreen as the active screen when (1) at least one touch point is detected on the first touchscreen and no touch points are detected on the second touchscreen, (2) the second touchscreen is substantially stable during a threshold period of time preceding when the multi-screen device is positioned in the tablet configuration.

Example 35 is a method that includes analyzing, by executing an instruction with at least one processor, touch points on at least one of a first touchscreen and a second touchscreen of a multi-screen device in response to a trigger event. The method further includes designating, by executing an instruction with at least one processor, one of the first and second touchscreens as an active screen and the other of the first and second touchscreens as an unused screen based on the touch points.

Example 36 includes the subject matter of Example 35, further including rendering media of a graphical user interface via the active screen and to deactivate the unused screen.

Example 37 includes the subject matter of anyone of Examples 35 or 36, wherein the touch points are detected within a threshold period of time following the trigger event.

Example 38 includes the subject matter of anyone of Examples 35-37, wherein the first touchscreen is associated with a first housing of the multi-screen device and the second touchscreen is associated with a second housing of the multi-screen device.

Example 39 includes the subject matter of Example 38, wherein the first and second housings are detachable from one another.

Example 40 includes the subject matter of Example 38, wherein the first and second housings are attached via a hinge. The first housing is rotatable about the hinge relative to the second housing to adjust the multi-screen device between the tablet configuration and a book configuration. Both the first touchscreen and the second touchscreen are visible from a single point of reference in the book configuration.

Example 41 includes the subject matter of Example 40, further including rendering a first portion of media via the first touchscreen and a second portion of the media via the second touchscreen when the multi-screen device is in the book configuration, and rendering both the first and second portions of the media via the active screen when the multi-screen device is in the tablet configuration.

Example 42 includes the subject matter of anyone of Examples 35-41, further including designating the first touchscreen as the active screen when the number of touch points detected on the second touchscreen is more than two at a single point in time.

Example 43 includes the subject matter of anyone of Examples 35-41, further including designating the first touchscreen as the active screen when the number of touch points detected on the second touchscreen is greater than the number of touch points detected on the first touchscreen at a point in time.

Example 44 includes the subject matter of Example 34, wherein the number of touch points detected on the first touchscreen is at least one at the point in time.

Example 45 includes the subject matter of anyone of Examples 35-44, wherein the trigger event corresponds to when the multi-screen device is placed into a tablet configuration. The tablet configuration is defined by the first and second touchscreens facing outwards and in opposite directions away from the multi-screen device.

Example 46 includes the subject matter of Example 45, further including designating the first touchscreen as the active screen when (1) at least one touch point is detected on the first touchscreen and no touch points are detected on the second touchscreen, (2) the second touchscreen is substantially stable during a threshold period of time preceding when the multi-screen device is positioned in the tablet configuration.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A computing device comprising:
a first housing having a first front side opposite a first back side, a first touchscreen on the first front side of the first housing;
a second housing having a second front side opposite a second back side, a second touchscreen on the second front side of the second housing, the first and second housings positionable in a tablet configuration with the first back side facing the second back side on the second housing; and
at least one processor to designate one of the first and second touchscreens as an active screen and the other of the first and second touchscreens as an unused screen based on touch points detected on at least one of the first and second touchscreens when the first and second housings are in the tablet configuration.

2. The computing device as defined in claim 1, wherein the at least one processor is to at least one of render media of a graphical user interface via the active screen and deactivate the unused screen.

3. The computing device as defined in claim 1, wherein the first and second housings are detachable from one another.

4. The computing device as defined in claim 1, wherein the first and second housings are attached via a hinge, the first and second housings adjustable about the hinge to move between the tablet configuration and a book configuration, both the first touchscreen and the second touchscreen are visible from a single point of reference in the book configuration.

5. The computing device as defined in claim 4, wherein the at least one processor is to render a first portion of media via the first touchscreen and a second portion of the media via the second touchscreen when the first and second housings are in the book configuration, the at least one processor to render both the first and second portions of the media via the active screen when the first and second housings are in the tablet configuration.

6. The computing device as defined in claim 1, wherein the at least one processor designates the first touchscreen as the active screen when more than two of the touch points are detected on the second touchscreen at a single point in time.

7. The computing device as defined in claim 1, wherein the at least one processor designates the first touchscreen as the active screen when more of the touch points are detected on the second touchscreen than on the first touchscreen at a point in time.

8. A computing device comprising:
a touch point analyzer to detect a number of touch points on at least one of a first touchscreen and a second touchscreen of a multi-screen device in response to a trigger event; and
a screen selector to designate one of the first and second touchscreens as an active screen and the other of the first and second touchscreens as an unused screen based on the number of touch points.

9. The computing device as defined in claim 8, wherein the first touchscreen is associated with a first housing of the multi-screen device and the second touchscreen is associated with a second housing of the multi-screen device.

10. The computing device as defined in claim 9, wherein the first and second housings are detachable from one another.

11. The computing device as defined in claim 9, wherein the first touchscreen is to display a first portion of media and the second touchscreen is to display a second portion of the media when the multi-screen device is in a book configuration, the active screen to display both the first and second portions of the media when the multi-screen device is in a tablet configuration.

12. The computing device as defined in claim 8, wherein the screen selector designates the first touchscreen as the active screen when the number of touch points detected on the second touchscreen is more than two at a point in time.

13. The computing device as defined in claim 8, wherein the screen selector designates the first touchscreen as the active screen when the number of touch points detected on the second touchscreen is greater than the number of touch points detected on the first touchscreen at a point in time.

14. The computing device as defined in claim 13, wherein the number of touch points detected on the first touchscreen is at least one at the point in time.

15. The computing device as defined in claim 8, wherein the trigger event corresponds to when the multi-screen device is placed into a tablet configuration, the tablet configuration defined by the first and second touchscreens facing outwards and in opposite directions away from the multi-screen device.

16. The computing device as defined in claim 15, wherein the screen selector designates the first touchscreen as the active screen when (1) at least one touch point is detected on the first touchscreen and no touch points are detected on the second touchscreen, and (2) the second touchscreen is substantially stable during a threshold period of time preceding when the multi-screen device is positioned in the tablet configuration.

17. A non-transitory computer readable medium comprising instructions that, when executed, cause a machine to at least:
analyze touch points on at least one of a first touchscreen and a second touchscreen of a multi-screen device in response to a trigger event; and
designate one of the first or second touchscreens as an active screen and the other of the first or second touchscreens as an unused screen based on the touch points.

18. The non-transitory computer readable medium as defined in claim 17, wherein the instructions further cause the machine to designate the first touchscreen as the active screen when the number of touch points detected on the second touchscreen is more than two at a single point in time.

19. The non-transitory computer readable medium as defined in claim 17, wherein the instructions further cause the machine to designate the first touchscreen as the active screen when the number of touch points detected on the second touchscreen is greater than the number of touch points detected on the first touchscreen at a point in time.

20. The non-transitory computer readable medium as defined in claim 17, wherein the trigger event corresponds to when the multi-screen device is placed into a tablet configuration, the tablet configuration defined by the first and second touchscreens facing outwards and in opposite directions away from the multi-screen device.

21. A method comprising:
analyzing, by executing an instruction with at least one processor, touch points on at least one of a first touchscreen and a second touchscreen of a multi-screen device in response to a trigger event; and
designating, by executing an instruction with at least one processor, one of the first and second touchscreens as an active screen and the other of the first and second touchscreens as an unused screen based on the touch points.

22. The method as defined in claim 21, further including designating the first touchscreen as the active screen when the number of touch points detected on the second touchscreen is more than two at a single point in time.

23. The method as defined in claim 21, further including designating the first touchscreen as the active screen when the number of touch points detected on the second touchscreen is greater than the number of touch points detected on the first touchscreen at a point in time.
